(19) United States
(12) Patent Application Publication
(10) Pub. No.: US 2010/0306841 A1
(43) Pub. Date: Dec. 2, 2010

(54) SECURITY SYSTEM AND METHOD FOR GRANTING ACCESS

(75) Inventor: KUI-JUN WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/647,399

(22) Filed: Dec. 25, 2009

(30) Foreign Application Priority Data
May 27, 2009 (CN) 200910302673.1

(51) Int. Cl. G06F 7/04

(52) U.S. Cl. 726/19

(57) ABSTRACT

A method for granting access to change a security system from a locked state to an unlocked state is provided. The method includes: displaying a security access interface on a display unit, wherein the security access interface comprises a first image input field and a second image input field; selecting one first image and at least one second image; moving the at least one selected second image to the selected first image; recording at least one property in relation to the selected first image and the at least one selected second image; generating an input password according to at least one of the at least one recorded property; determining whether the input password matches a predetermined password; and granting access if the input password matches the predetermined password. A related security system is also provided.

### BACKGROUND

1. Technical Field

The present disclosure relates to security systems, and more particularly to a security system and a method for granting access used by the security system.

2. Description of Related Art

A conventional password often includes numerical numbers and/or letters, such as, 0-9, and a-z/A-Z. However, input devices used for inputting password information are substantially similar, and locations of the numbers and the letters arranged in the input device are almost uniform and common. Accordingly, passwords can easily be figured out merely by observing how they are input.

### BRIEF DESCRIPTION OF THE DRAWINGS

The components of the drawings are not necessarily drawn to scale, the emphasis instead being placed upon clearly illustrating the principles of a security system and a method for granting access. Moreover, in the drawings, like reference numerals designate corresponding parts throughout several views.

FIG. 1 is a block diagram of a security system in accordance with an exemplary embodiment.

FIG. 2 is a schematic diagram showing a security access interface generated by the security system of FIG. 1.

FIG. 3 is a schematic diagram showing a plurality of storage names of first images displayed on the security access interface of FIG. 2.

FIG. 4 is a schematic diagram showing a plurality of storage names of second images displayed on the security access interface of FIG. 2.

FIG. 5 is a schematic diagram showing one selected first image and a plurality of selected second images displayed on the security access interface of FIG. 2.

FIG. 6 is a schematic diagram of showing the selected second images of FIG. 5 moved to the selected first image of FIG. 5.

FIG. 7 is a flowchart of a method for granting access in accordance with the embodiment.

### DETAILED DESCRIPTION

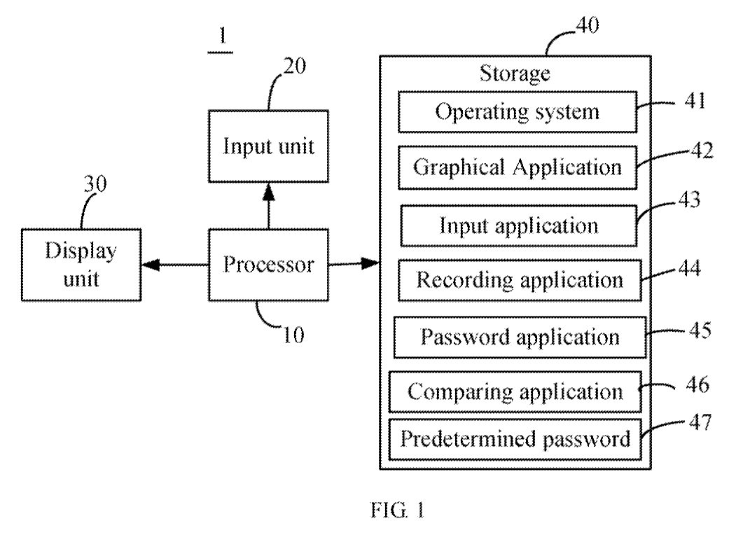

Referring to FIG. 1, a block diagram of a security system 1 in accordance with an exemplary embodiment is shown. The system 1 generally includes a processor 10, an input unit 20, a display unit 30, and a storage 40.

The processor 10 executes/runs various software components in the storage 40 to perform various functions for the security system 1, and controls the operations of the security system 1.

The input unit 20 is configured to generate instructions in response to user inputs. In the embodiment, the input unit 20 includes at least one physical button. In an alternative embodiment, the input unit 20 can be a touch pad.

The display unit 30 is configured to output graphical data. The visual outputs may include text, graphic, video, and any combination thereof. The display unit 30 can be a touch sensitive display unit.

The storage 40 stores an operating system 41, a graphical application 42, an input application 43, a recording application 44, a password application 45, a comparing application 46, and a predetermined password 47 used for authenticating an inputted password.

The operating system 41 (e.g., LINUX®, UNIX®, WINDOWS®, or an embedded operating system 41 such as VxWorks®) includes various procedures, sets of instructions, software components and/or drivers for controlling and managing general system tasks (e.g., memory management, storage control, and power management, etc.) and facilitating communication between various hardware and software components.

The graphical application 42 includes various software components and/or set of instructions, which may be implemented by the processor 10 for rendering and displaying graphical user interfaces (GUI) on the display unit 30. It should be noted that the GUI can include any object that can be displayed, including, text, web pages, digital images, videos, animations and the like.

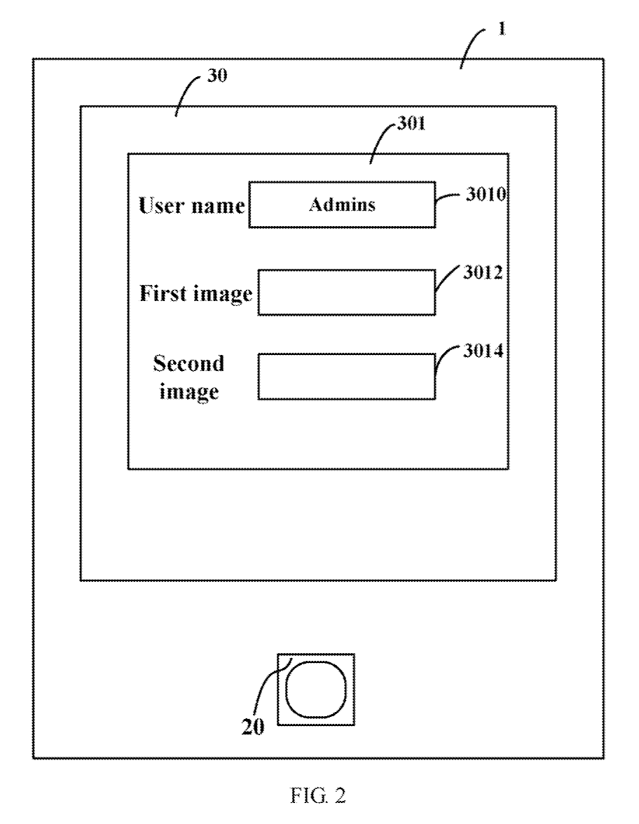

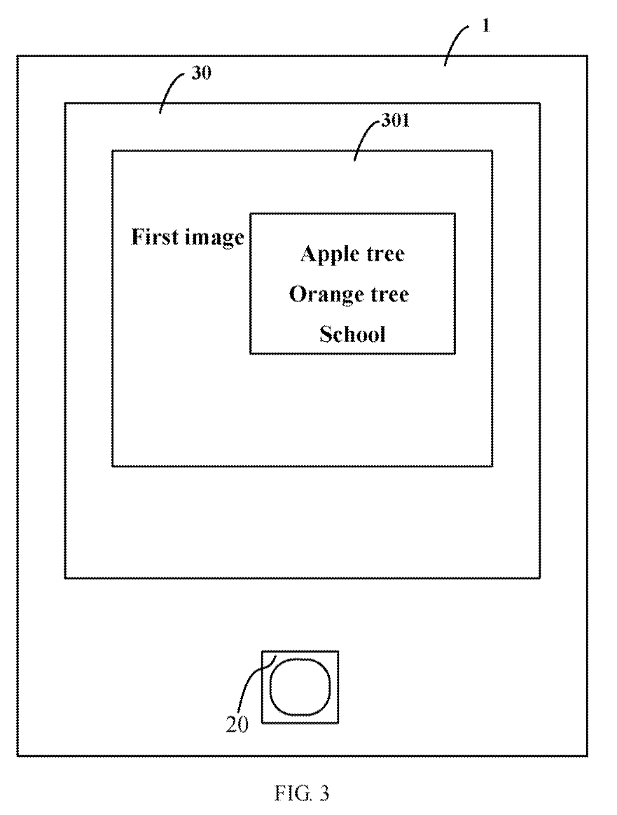

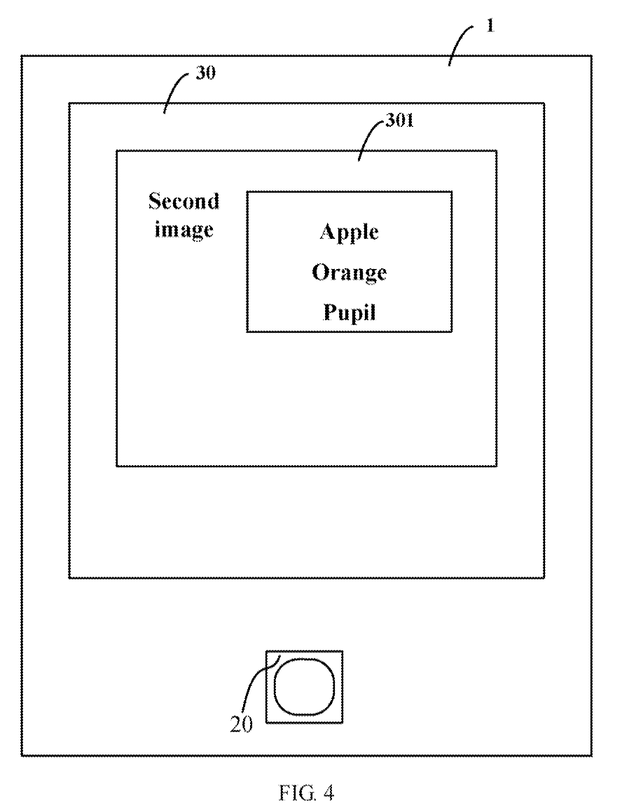

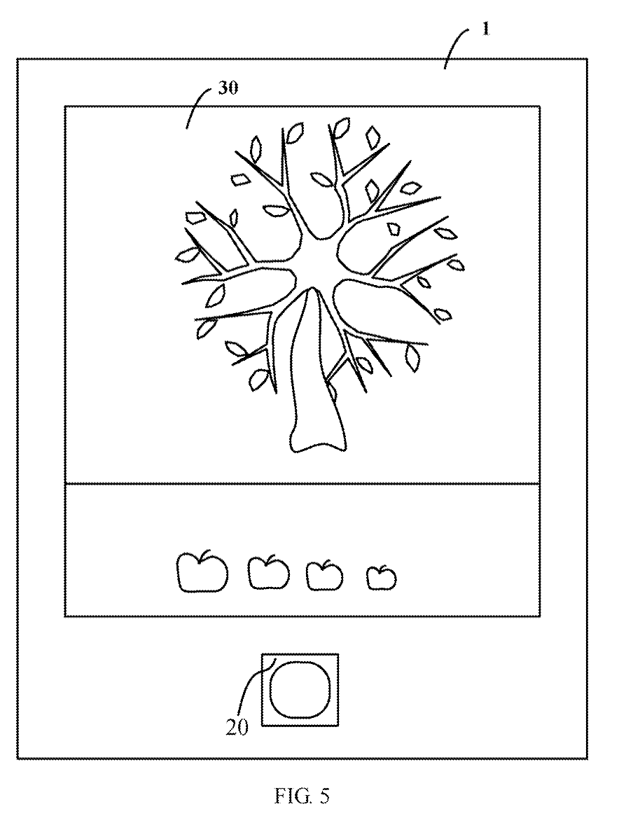

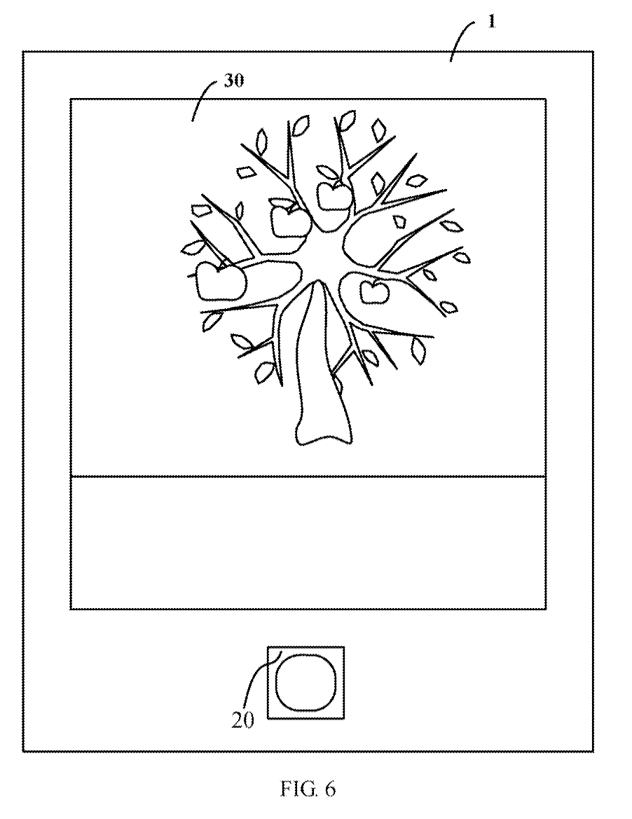

Referring also to FIG. 2, when the system is triggered to prompt for accessing/unlock operations (procedures), the graphical application 42 is implemented by the processor 10 to display a security access interface 301 on the display unit 30. The interface 301 includes a user name input field 3010, a first image input field 3012, and a second image input field 3014. The user name input field 3010 is configured for a user to input one user name. The first image input field 3012 is configured for the user to select one first image. As shown in FIG. 3, when the first image input field 3012 is triggered, a plurality of storage names of first images for example Apple tree, Orange tree, and School, is displayed on the interface 301 for the user to select one of the first images. The second image input field 3014 is configured for the user to select one kind of second image. Each kind of second image includes at least one image. As shown in FIG. 4, when the second image input field 3014 is triggered, a plurality of storage names of second images for example Apple, Orange, and Pupil, is displayed on the interface 301 for the user to select one kind of second image. As shown in FIG. 5, when the user selects one first image and one kind of second image, the selected first image and the at least one selected second image are displayed on the display unit 30. In the embodiment, an image of an apple tree and four images of apples are selected. As shown in FIG. 6, when the selected first image and the at least one selected second image are displayed, the user can move the least one selected second image to the first image in sequence. In the embodiment, the images of apples are moved to the image of the apple tree in sequence.

In an alternative embodiment, when the first image input field 3012 or the second image input filed 3014 is triggered, a plurality of thumbnail images of the first images or a plurality of thumbnail images of the second images is displayed on the interface 301 for the user to select one first image or one kind of second image.

The input application 43 includes various software components and/or set of instructions, which can be invoked/implemented by the processor 10 for receiving instructions from the input unit 20, and performing various functions for example moving the at least one selected second image to the selected first image according to the received instructions.

The recording application 44 includes various software components and/or set of instructions, which can be invoked/implemented by the processor 10 for recording at least one property in relation to the selected first image and the at least one selected second image. In the embodiment, the at least one property includes at least one position relationship between the selected first image and the at least one selected second image. That is, the recording application 44 is invoked/implemented to record which position the at least one second image stays on the selected first image. The recording application 44 can also be invoked/implemented to record a sequence of moving the at least one selected second image to the selected first image. The recording application 44 can further be invoked/implemented to record the storage name of the selected first image, the storage path of the selected first image, the storage name of the at least one selected second image, the storage path of the at least one selected second image, the number of the at least one selected second image, and so on.

The password application 45 includes various software components and/or set of instructions, which can be invoked/implemented by the processor 10 for generating an input password according to at least one of the at least one recorded property. In the embodiment, the password application 45 generates the input password according to the at least one position relationship between the selected first image and the at least one selected second image. In an alternative embodiment, the password application 45 is invoked/implemented to generate the input password according to the sequence of moving the at least one selected second image to the selected first image, or according to a combination of the at least one recorded position relationship and the recorded sequence, or according to a combination of the at least one recorded position relationship, the recorded sequence, the recorded storage name and the recorded storage path of the selected first image, the recorded storage name and the recorded storage path of the at least one selected second image, and the number of the at least one selected second image. In the embodiment, when a confirm instruction is received from the input unit 20, the password application 45 is invoked/implemented by the processor 10 to generate the input password.

Furthermore, the input password can be defined as a newly predetermined password to replace the previously predetermined password 47 stored in the storage 40.

The comparing application 46 includes various software components and/or set of instructions, which can be invoked/implemented by the processor 10 for comparing the input password with the predetermined password 47. When the input password matches the predetermined password 47, the security system 1 is unlocked. Otherwise, the security system 1 remains locked.

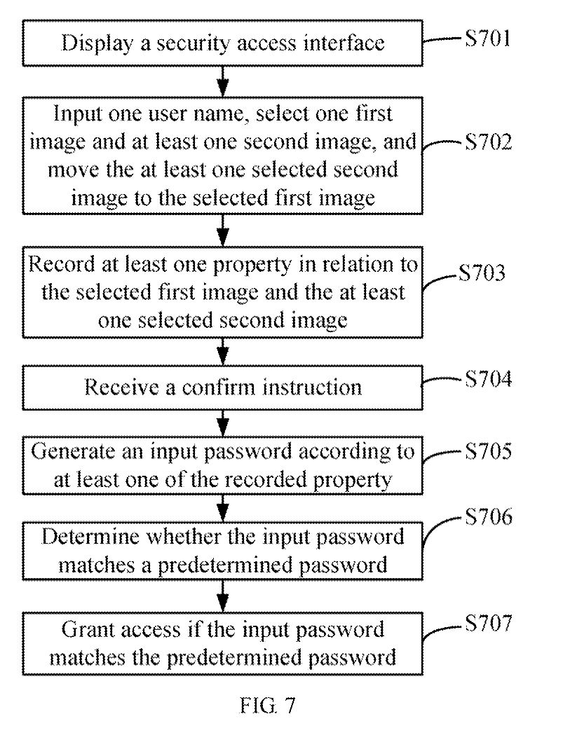

Referring to FIG. 7, a flowchart illustrating a method applied using the security system 1 of FIG. 1 for granting access is shown. The method includes the following blocks, each of which is tied to various modules contained in the security system 1 as shown in FIG. 1.

In step S701, in operation, the processor 10 invokes/implements the graphical application 42 to display the security access interface 301 on the display unit 30. In the embodiment, the interface 301 includes the user name input field 3010, the first image input filed 3012, and the second image input field 3014.

In step S702, the processor 10 invokes/implements the input application 43 to receive user instructions from the input unit 20, thereby, inputting one user name, selecting one first image and one kind of second image, and moving the at least one selected second image to the selected first image.

In step S703, the processor 10 invokes/implements the recording application 44 to record at least one property in relation to the selected first image and the at least one selected second image. In the embodiment, the at least one property includes at least one position relationship between the selected first image and the at least one selected second images. The at least one property can also include a sequence of moving the at least one selected second image to the selected first image. The at least one property can further include the storage name of the selected first image, the storage path of the selected first image, the storage name of the at least one selected second image, the storage path of the at least one selected second image, and the number of the at least one selected second image.

In step S704, the processor 10 invokes/implements the input application 43 to determine whether a confirm instruction is received from the input unit 20.

In step S705, if the confirm instruction is received, the processor 10 invokes/implements the password application 45 to generate an input password according to at least one of the at least one recorded property. In the embodiment, the password application 45 generates the input password according to the at least one position relationship between the selected first image and the at least one selected second image. In an alternative embodiment, the password application 45 is invoked/implemented to generate the input password according to the sequence of moving the at least one selected second image to the selected first image, or according to a combination of the at least one recorded position relationship and the recorded sequence, or according to a combination of the at least one recorded position relationship, the recorded sequence, the recorded storage name and the recorded storage path of the selected first image, the recorded storage name and the recorded storage path of the at least one selected second image, and the number of the at least one selected second image.

In step S706, the processor 10 invokes/implements the comparing application 46 to determine whether the input password matches the predetermine password 47 in the storage 40.

In step S707, the processor 10 triggers the security system 1 to grant access/unlock operations (procedures) if the input password matches the predetermined password 47.

As described above, the user is granted access by selecting one first image and one kind of second image, and moving at least one selected second image to the selected first image in sequence, thereby, protecting the password more safely and efficiently as it cannot be easily determined by mere observation since fixed patterns of input options are not being displayed.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A security system comprising:
a display unit;
an input unit configured for generating instructions in relation to user input;
a storage storing a predetermined password and a plurality of modules; and
a processor executing the plurality of modules;
wherein the plurality of modules comprises instructions executable by the processor to:
display a security access interface on the display unit, wherein the security access interface comprises a first image input field and a second image input field, the first image input field is configured for selecting one first image, and the second image input field is configured for selecting one kind of second image, each kind of second image comprises at least one second image;
select one first image and one kind of second image and move the at least one selected second image to the selected first image in sequence according to the received instructions from the input unit;
record at least one property in relation to the selected first image and the at least one selected second image;
generate an input password according to at least one of the at least one recorded property;
determine whether the input password matches the predetermined password; and
grant access when the input password matches the predetermined password.

2. The security system as described in claim 1, wherein the at least one recorded property comprises at least one position relationship between the selected first image and the at least one second image.

3. The security system as described in claim 2, wherein the at least one record property further comprises a sequence of moving the at least one selected second image to the selected first image.

4. The security system as described in claim 2, wherein the plurality of modules comprises instructions executable by the processor to generate the input password according to the at least one of the at least one recorded property comprises: the plurality of modules comprises instructions executable by the processor to generate the input password according to the at least one recorded position relationship between the selected first image and the at least one second image.

5. The security system as described in claim 3, wherein the plurality of modules comprises instructions executable by the processor to generate the input password according to the at least one of the at least one recorded property comprises: the plurality of modules comprises instructions executable by the processor to generate the input password according to the sequence of moving the at least one selected second image to the selected first image.

6. The security system as described in claim 3, wherein the plurality of modules comprises instructions executable by the processor to generate the input password according to the at least one of the at least one recorded property comprises: the plurality of modules comprises instructions executable by the processor to generate the input password according to the at least one position relationship between the selected first image and the at least one second image and the sequence of moving the at least one selected second image to the selected first image.

7. The security system as described in claim 1, wherein the plurality of modules further comprises instructions executable by the processor to:
determine whether a confirm instruction is received; and
generate the input password if the confirm instruction is received.

8. The security system as described in claim 1, wherein the plurality of modules further comprises instructions executable by the processor to:
keep the security system in a locked state if the input password does not match the predetermined password.

9. A method for granting access to change a security system from a locked state to an unlocked state, the method comprising:
displaying a security access interface on a display unit, wherein the security access interface comprises a first image input field and a second image input field, the first image input field is configured for selecting one first image, and the second image input field is configured for selecting one kind of second images, each kind of second image comprises at least one second image;
selecting one first image and one kind of second images;
moving the at least one selected second image to the selected first image in sequence;
recording at least one property in relation to the selected first image and the at least one selected second image;
generating an input password according to at least one of the at least one recorded property;
determining whether the input password matches a predetermined password; and
granting access if the input password matches the predetermined password.

10. The method as described in claim 9, wherein the at least one recorded property comprises at least one position relationship between the selected first image and the at least one second image.

11. The method as described in claim 10, wherein the at least one record property further comprises a sequence of moving the at least one selected second image to the selected first image.

12. The method as described in claim 10, wherein generating an input password according to at least one of the at least one recorded property comprises: generating the input password according to the at least one recorded position relationship between the selected first image and the at least one second image.

13. The method as described in claim 11, wherein generating an input password according to at least one of the at least one recorded property comprises: generating the input password according to the sequence of moving the at least one selected second image to the selected first image.

14. The method as described in claim 11, wherein generating an input password according to at least one of the at least one recorded property comprises: generating the input password according to the at least one position relationship between the selected first image and the at least one second image and the sequence of moving the at least one selected second image to the selected first image.

15. The method as described in claim 9, further comprising:
determining whether a confirm instruction is received; and
generating the input password if the confirm instruction is received.

16. The method as described in claim 9, further comprising:
keeping the security system in the locked state if the input password does not match the predetermined password.
